(19) United States
(12) Patent Application Publication
(10) Pub. No.: US 2026/0038065 A1
(43) Pub. Date: Feb. 5, 2026

(54) METHODS AND SYSTEMS FOR ONBOARDING A BUILDING MANAGEMENT SYSTEM

(71) Applicant: Honeywell International Inc., Charlotte, NC (US)

(72) Inventor: Naveen Panduranga Prabhu, Sagara (IN)

(21) Appl. No.: 18/791,439

(22) Filed: Aug. 1, 2024

(51) Int. Cl. G06Q 50/163; G16Y 40/35

(52) U.S. Cl. CPC G06Q 50/163; G16Y 40/35

(57) ABSTRACT

A method of onboarding a Building Management System (BMS) is disclosed. The method includes receiving, by one or more cloud tools, a user input for enabling recording of historical data associated with a set of data points from a plurality of data points pertaining to the BMS. Further, the method includes publishing, by the one or more cloud tools to an IoT service, a system command generated based on the set of data points, in response to receiving the user input for enabling recording of historical data associated with the set of data points. Further, the method includes transmitting, by the IoT service, the system command to a client environment in which the BMS is implemented for enabling the recording of the historical data associated with the set of data points at the BMS.

### TECHNICAL FIELD OF THE INVENTION

The present subject matter relates to BMS onboarding solutions and, more particularly, to systems and methods for onboarding a BMS.

### BACKGROUND OF THE INVENTION

Onboarding a Building Management System (BMS) to a cloud platform involves several key steps. Initially, a model synchronization may be performed using cloud connectors, which transfer all data points from the BMS to the cloud. Following the synchronization, a contextualization process is executed on these data points. This process assigns appropriate roles to the raw data points and organizes them into logical assets.

Once the data points have been contextualized and categorized based on their roles and associated assets, the data points may be confirmed and exported into an Excel file. The file is then sent to a field technician. In the conventional method, the field technician manually enables the history for each data point in the BMS system at the client site. This manual process is time-consuming and often requires the technician to visit the client site, thereby incurring additional costs for onboarding.

The existing solutions involves multiple steps that are either time consuming or adding cost to the onboarding process. For instance, after modelling, the cloud engineer sends the file to the site technician and has to wait until the site technician adds the data points into the system before moving to the next onboarding process. This adds delay in the entire onboarding the site. Further, operational expenses are also increased.

### SUMMARY OF THE INVENTION

The present subject matter discloses methods and systems for onboarding a Building Management System (BMS).

In an embodiment, a method of onboarding a Building Management System (BMS) is disclosed. The method includes receiving, by one or more cloud tools, a user input for enabling recording of historical data associated with a set of data points from a plurality of data points pertaining to the BMS. Further, the method includes publishing, by the one or more cloud tools to an IoT service, a system command generated based on the set of data points, in response to receiving the user input for enabling recording of historical data associated with the set of data points. Further, the method includes transmitting, by the IoT service, the system command to a client environment in which the BMS is implemented for enabling the recording of the historical data associated with the set of data points at the BMS.

In some embodiments, the method includes receiving, by the one or more cloud tools, the plurality of data points, wherein the plurality of data points corresponds to one or more subsystems of the BMS. Further, the method includes performing, by the one or more cloud tools, one or more contextualization operations on the plurality of data points for obtaining structured data, wherein the structured data comprises the plurality of data points mapped to one or more subsystems of the BMS, and wherein each of the plurality of data points is assigned a point role.

In some embodiments, the method includes displaying, using the one or more cloud tools, the plurality of data points in the structured format to a user. The method further includes receiving, using the one or more cloud tools, a selection of the set of data points selected by the user from the plurality of data points pertaining to the BMS displayed to the user. The method further includes displaying, for selection, an enable history option to the user, in response to receiving the selection of the set of data points from the user.

In some embodiments, the method includes receiving the recorded historical data corresponding to the set of data points after predetermined time intervals. The method further includes determining, by the IoT service, successful receipt of the recorded historical data after the predetermined intervals. Further, the method includes generating, by IoT service, an alert message on determining that the reception of recorded historical data is disabled or interrupted.

In another embodiment, a method of onboarding a Building Management System (BMS) is disclosed. The method includes receiving, by a server implemented in a client environment, a system command for enabling recording of historical data associated with a set of data points from a plurality of data points pertaining to the BMS implemented in the client environment. Further, the method includes identifying, by the server based on the system command, one or more subsystems of the BMS that are corresponding to the set of data points. Further, the method includes transmitting, by the server, an enable history message to one or more cloud connectors corresponding to the one or more subsystems of the BMS for enabling recording of the historical data associated with the set of data points. The enable history message comprises a gateway identity associated with the one or more subsystems, an enable history command, and information associated with the set of data points that are to be captured at the one or more subsystems.

In some embodiments, the method includes obtaining, by the one or more cloud connectors, the historical data corresponding to the set of data points from the one or more subsystems of the BMS after a predetermined interval. The method further includes transmitting, by the one or more cloud connectors, the obtained historical data corresponding to the set of data points to the server for transmitting to a cloud IoT service.

In another embodiment, a system for onboarding a Building Management System (BMS) is disclosed. The system comprises one or more cloud tools, an IoT service, one or more processors. The system is configured to receive, by one or more cloud tools, a user input for enabling recording of historical data associated with a set of data points from a plurality of data points pertaining to the BMS. Further, the system is configured to publish, by the one or more cloud tools to the IoT service, a system command generated based on the set of data points, in response to receiving the user input for enabling recording of historical data associated with the set of data points. Further, the system is configured to transmit, by the IoT service, the system command to a client environment in which the BMS is implemented for enabling the recording of the historical data associated with the set of data points at the BMS.

In another embodiment, a system for onboarding a Building Management System (BMS) is disclosed. The system comprises a plurality of cloud connectors, one or more subsystems of the BMS, and one or more processors. The one or more processors are configured to receive, from a cloud IoT service, a system command for enabling recording of historical data associated with a set of data points from a plurality of data points pertaining to the BMS. Further, the one or more processors are configured to identify, based on the system command, one or more subsystems of the BMS that are corresponding to the set of data points. Further, the one or more processors are configured to transmit an enable history message to one or more cloud connectors corresponding to the one or more subsystems of the BMS for enabling recording of the historical data associated with the set of data points.

In yet another embodiment, a computer-readable medium having computer-executable instructions stored thereon is disclosed. The computer-executable instructions, when executed by a processing system, cause the processing system to receive a user input for enabling recording of historical data associated with a set of data points from a plurality of data points pertaining to the BMS. The computer-executable instructions further cause the processing system to publish a system command generated based on the set of data points, in response to receiving the user input for enabling recording of historical data associated with the set of data points. The computer-executable instructions further cause the processing system to transmit the system command to a client environment in which the BMS is implemented for enabling the recording of the historical data associated with the set of data points at the BMS.

In yet another embodiment, a computer-readable medium having computer-executable instructions stored thereon is disclosed. The computer-executable instructions, when executed by a processing system, cause the processing system to receive a system command for enabling recording of historical data associated with a set of data points from a plurality of data points pertaining to the BMS. The computer-executable instructions further cause the processing system to identify one or more subsystems of the BMS based on the system command. The computer-executable instructions further cause the processing system to transmit an enable history message to one or more cloud connectors corresponding to the one or more subsystems of the BMS for enabling recording of the historical data associated with the set of data points.

The proposed solution helps achieve reduction in time associated with the onboarding of the BMS. For instance, implementation of the system command helps mitigate the requirement for site technician visit, which may typically take one or more days. Furthermore, operational costs associated with the services of the site technician are averted.

### BRIEF DESCRIPTION OF DRAWINGS

Embodiments of the subject matter will hereinafter be described in conjunction with the following drawing figures, wherein like numerals denote like elements, and:

FIG. 1 illustrates an environment implementing a system for onboarding a Building Management System (BMS), according to one or more embodiments of the present disclosure.

FIG. 2 is a schematic block diagram of the system, according to one or more embodiments of the present disclosure.

FIG. 3 illustrates a flowchart of a method of onboarding a BMS, according to one or more embodiments of the present disclosure.

FIG. 4 illustrates a flowchart of a method of onboarding a BMS, according to one or more embodiments of the present disclosure.

FIG. 5 illustrates a call flow diagram, according to one or more embodiments of the present disclosure;

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF INVENTION

The following description should be read with reference to the drawings, in which like elements in different drawings are numbered in like fashion. The drawings, which are not necessarily to scale, depict examples that are not intended to limit the scope of the disclosure. Although examples are illustrated for the various elements, those skilled in the art will recognize that many of the examples provided have suitable alternatives that may be utilized.

As used in this specification and the appended claims, the singular forms “a”, “an”, and “the” include the plural referents unless the content clearly dictates otherwise. As used in this specification and the appended claims, the term “or” is generally employed in its sense including “and/or” unless the content clearly dictates otherwise.

It is noted that references in the specification to “an embodiment”, “some embodiments”, “other embodiments”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is contemplated that the feature, structure, or characteristic may be applied to other embodiments whether or not explicitly described unless clearly stated to the contrary.

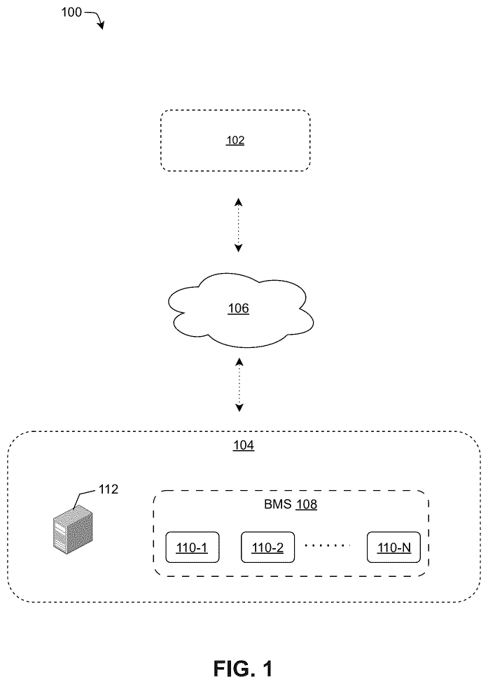

FIG. 1 illustrates an environment 100 implementing a system 102 for onboarding a Building Management System (BMS), according to one or more embodiments of the present disclosure. The environment 100 may include the system 102 and a client environment 104 representing one or more systems, subsystems, computing devices, sensors, etc. of an enterprise.

In some embodiment, the system 102 may be implemented by a service provider for collection and management of data pertaining to one or more operational systems implemented in the client environment 104. Herein, a subscription or a license to the services offered by the service provider may be taken by the enterprise. In some examples, the operations of the operational systems may be managed using a BMS 108. Accordingly, for collection and management of the data pertaining to the operational systems, the system 102 may facilitate onboarding of the BMS 108 implemented in the client environment 104.

In an embodiment, the system 102 may be implemented as a cloud server or a cloud service. In some embodiments, the system 102 may be implemented locally at a site of the enterprise, i.e., within the client environment 104. In some embodiments, the system 102's services may be offered as per a Software as a Service (SaaS) model. In some embodiments, the system 102 may be implemented in any one of or a combination of the aforementioned implementation techniques for onboarding the BMS 108.

In some embodiment, the system 102 may include one or more cloud tools (not shown in this figure), a cloud server including processors (not shown in this figure), one or more databases (not shown in this figure), one or more cloud IoT services (not shown in this figure), etc. The one or more cloud tools may be cloud applications used for performing operations, such as data synchronization, data grouping, etc., on data received from the client environment 104. The data, herein, may relate to one or more systems of the BMS 108.

The one or more servers included in the system 102 may be entrusted with various operations, such as monitoring the data received from the client environment 104, sending and receiving commands to/from the client environment 104, etc., for example, using one or more IoT services. In some embodiments, the cloud tools and the IoT services may be implemented on the one or more servers. In some embodiments, one or more of the cloud tools and the IoT services may run on a computing device which may be coupled With a server for performing the aforementioned operations or one or more of the other operations as described in the present disclosure.

In some embodiments, the cloud service may be an Internet of things (IoT) service. In an example, the IoT service may have a secure connection with a computing device, such as a server 112, of the client environment 104 for obtaining data associated with the BMS 108 and for sending the commands from the system 102 to the client environment 104.

Further, the databases included in the system 102 may be used for recording the data received from the client environment 104. In other examples, the database may store data generated within the system 102, for example, during the operations of the cloud tools.

The system 102 may be communicatively coupled with the client environment 104 through a communication network 106 (interchangeably “the network 106”). The network 106 may be understood as a network, including personal computers, laptops, various servers and other computing devices. Further, the network 106 may be a wireless network, a wired network, or a combination thereof. The network 106 may also be an individual network or a collection of many such individual networks, interconnected with each other and functioning as a single large network, e.g., the Internet or an intranet. The network 106 may be implemented as one of the different types of networks, such as intranet, local area network (LAN), wide area network (WAN), the internet, and such. The network 106 may either be a dedicated network or a shared network, which represents an association of the different types of networks that use a variety of protocols, for example, Hypertext Transfer Protocol (HTTP), Transmission Control Protocol/Internet Protocol (TCP/IP), etc., to communicate with each other. Further, the network 106 may include network devices, such as network switches, hubs, routers, and Host Bus Adapters (HBAs) for providing a link between the system 102 and the client environment 104. The network devices within the network 106 may interact with the system 102 and the client environment 104 through various communication links (not shown in the figure).

Referring to the client environment 104, in some embodiments, the client environment 104 may be an enterprise, a factory site, a housing society, a power plant, a thermal plant, a manufacturing facility, etc. The client environment 104, among other things, may include the BMS 108 and the server 112.

In an example, the BMS 108 may be implemented for management of the one or more subsystems 110-1, 110-2, . . . , 110-n (interchangeably “the subsystems 110”) present in the client environment 104. Examples of the subsystems 110 may include, but are not limited to, an HVAC (Heating, Ventilation, and Air Conditioning) system, a Lighting Control System, a Fire and Life Safety System, and a plumbing and water management system. As may be understood, the subsystems 110 help manage operations in the client environment 104. For example, the Lighting Control System may be used to manage, operate, and record data associated with the lighting in different areas of the client environment 104.

The server 112 may be a central server implemented in the client environment 104 and may be used to monitor, collect, store, manage, data related to subsystems 110 of the BMS 108. In some examples, the server 112 may also function as a communication node with the system 102. Herein, the server 112 may exchange communication messages, i.e., send/receive communication messages with the system 102. Furthermore, the server 112 may be configured to transmit messages and commands between the system 102 and the BMS 108.

As mentioned above, the system 102 may onboard the BMS 108. The onboarding of the BMS 108 may include several operations, such as model sync and data contextualization, data point selection, and enabling history of the selected data points. The aforementioned operations may be performed at one or more of the system 102 and the client environment 104.

In some embodiments, in the initial operations for the on-boarding of the BMS 108, the system 102 may be configured to receive data related to the BMS 108 from the client environment 104. The data may include a plurality of data points corresponding to each of the subsystems 110. The data may further include information about a point role assigned with each of the data points. For example, consider an example where the client environment 104 is a factory. The factory may an HVAC (Heating, Ventilation, and Air Conditioning) system or a Lighting Control System. In said example, the data points may be values indicative of operational metrics of the HVAC system and the point role may define the characteristic of the data point. For instance, the point role may be a temperature value and the data point may be, say, twenty degree. The data may further include information about a point of deployment, i.e., a location, of a sensor at which the data point was collected. As an example, a sensor which recorded the temperature value of twenty degree may be deployed in a ground floor room. Accordingly, the data may include the location, say, ground floor Room A, associated with the temperature value data point role.

In some examples, the system 102 may perform model sync and data contextualization operations on the data received for sorting and arranging the data. That is, the system 102 segregates the data points corresponding to the subsystems 110 implemented in the cloud environment 104. Furthermore, the information associated with the data points is also listed in the categorized fashion. For instance, details of the data point role and location may be listed along with the data points.

According to aspects of the present disclosure, once the data operations are performed on the data received from the BMS 108, the system 102 may be configured to facilitate selection of a set of data points for which history is to be enabled. In some examples, the selection of the set data points may be performed dynamically as desired by a user working with the enterprise. In some examples, the selection of the set of data points may be done remotely. In some examples, the selection of the set data points may include a site visit to a site of the system 102 by the user. In some examples, the selection of the set of data points may be provided to the system 102 in a file, as an attachment to a communication message.

In some examples, the selection of the data points may be based on predefined sets that are prestored or generated intelligently by the system 102. For instance, the system 102 may have a predefined set of data points which may be provided to the user, for example, on a display device. If found in order, the user may approve and select the predefined set of data points. Herein, the system 102 may customize the predefined set based on edits done by the user. In some examples, the system 102 may generate the predefined set of data points by applying one or more AI based techniques on the received data from the BMS 108.

According to aspects of the present disclosure, the system 102 may facilitate publishing and transmission of a command(s) to the client environment 104, for facilitating collection of historical data associated with the set of data points selected by the user. The command, in some examples, may include information about the set of data points and metadata associated with the set of data points. The metadata may include information, such as point roles, associated subsystems 110, location of the data point, etc.

For example, the metadata may be indicative of the associated room/floor and the corresponding sub-system for which the user wants to facilitate collection of historical data at the system 102. In above example, the metadata associated with the room/floor may indicates the physical location in the client environment 104 and the metadata of the corresponding sub-system may specify the sub-system of the BMS that generated said data. In an embodiment, the metadata associated with the data point may acts like a label on the data points, providing details about their origin and surroundings in the client environment 104.

In an example, the system 102 may transmit the system command to the server 112 of the client environment using the cloud services (not shown in the figure), for example, over the communication network 106.

At the client environment 104, the server 112 may be configured to receive the system command from the system 102. The server 112 may accordingly communicate with the subsystems 110 of the BMS 108 and facilitate collection of historical data associated with the data points pertaining to the subsystems 110. The recorded historical data is subsequently sent to the system 102 by the server 112.

Conventionally, for facilitating the recording of the historical data associated with the selected data points, a site visit at a location of the client environment 104 was required to be performed by a site technician. As may be gathered, such action required coordinating the visit which was dependent on the availability of the site technician and often took several days to complete. Furthermore, the aforementioned was also a cost incurring exercise which increased the overall cost for onboarding the BMS 108. By publishing and transmitting the command to the client environment 104, the system 102 averts the requirement for a site technician by the site technician. Thus, the time taken for onboarding the BMS 108 and the associated costs are significantly reduced.

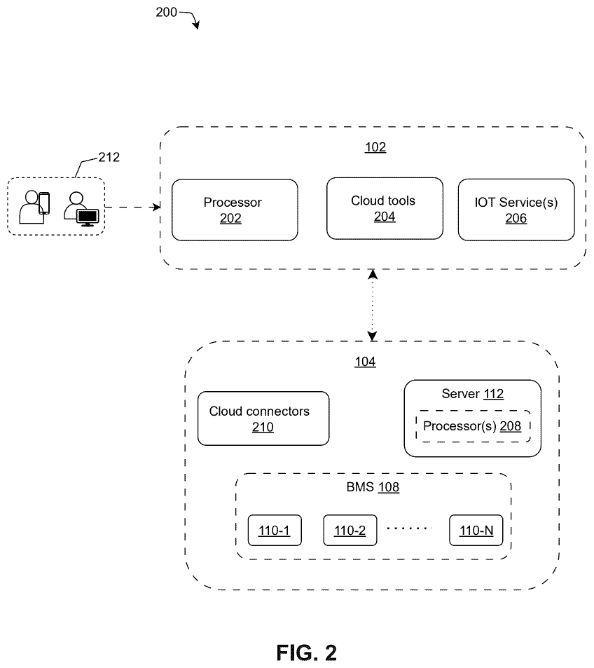

FIG. 2 is a schematic block diagram 200 illustrating one or more components of the system 102 for onboarding a Building Management System (BMS) of the client environment 104, according to one or more embodiments of the present disclosure. In an example, the system 102 may be implemented as a cloud server or a cloud service. In some embodiments, the system 102 may be implemented locally at a site of an enterprise, i.e., within the client environment 104. In some embodiments, the system 102's services may be offered as per a Software as a Service (SaaS) model. In some embodiments, the system 102 may be implemented in any one of or a combination of the aforementioned implementation techniques for onboarding the BMS. In an embodiment, the system 102 may include at least one processor 202, one or more cloud tools 204, and one or more IOT services 206.

The processor 202, in some examples, may be implemented or realized as general purpose processors, a content addressable memory, a digital signal processor, an application specific integrated circuit, a field programmable gate array, any suitable programmable logic device, discrete gate or transistor logic, discrete hardware components, or any combination designed to perform the functions described here. In some examples, the processor 202 may be realized as microprocessors, controllers, microcontrollers, or state machines. In some examples, the processor 104 may be realized as a combination of computing devices, such as, a combination of digital signal processors and microprocessors, a plurality of microprocessors, one or more microprocessors in conjunction with a digital signal processor core, or any other such combination/configuration. In some embodiments, one or more processors, such as the processor 202 or equivalents thereof, may be provided for performing operations thereof, as described herein. In an embodiment, the processor 202 may be implemented in a server (not shown in the figure) at the system 102.

The cloud tools 204 may be understood as computer applications running in a cloud environment which are used for performing one or more operations on data received from the client environment 104, for example, during the onboarding of the BMS or subsequently during the operations of the BMS. In an example, the one or more operations may be at least data synchronization, contextualization, providing the data for displaying, etc.

The IoT Service 206, as used herein, may be understood as one or more IoT applications and/or services and/or routines and/or programs running in the system 102. In some examples, the IoT services 206 may be configured to process, manage, and store data pertaining to the BMS that is received at the system 102. The aforementioned data may be collected by the one or more subsystems of the BMS, for example, using one or more IoT devices or other sensors or other devices implemented in the client environment 108.

As an example, at least one temperature sensor and at least one humidity sensor may be implemented, say, in a cold storage which is managed by a temperature monitoring subsystem of the BMS. Herein, the temperature monitoring subsystem may collect data from the temperature sensor and the humidity sensor at periodic intervals or as per predetermined configuration. The data, thus collected, is transmitted to the system 102 by the BMS. In some examples, the data may be sent to the system 102 using the communication networks 106.

At the system 102, the IoT service 206 may receive the data transmitted by the BMS for further processing. In an embodiment, the IoT service 206 may be coupled to the processor 202. In some embodiments, the cloud tools 204 and the IoT service 206 may be implemented on the cloud server. In some embodiments, the cloud tools 204 and the IoT service 206 may run on a computing device which may be coupled with the cloud server for performing the one or more of the other operations as described in the present disclosure. In some embodiments, the cloud tools 204 may be operatively coupled to the IoT service 206 and the processor 202.

The block diagram 200 further illustrates one or more components of the client environment 104. As illustrated, the client environment 104 includes the BMS 108, the server 112 one or more cloud connectors 210. The server 112 may comprise one or more processors (not shown in the figure) for performing the one or more of the other operations as described in the present disclosure. In an example, the processor comprised in the server 112 may be same as the processor 202.

The cloud connectors 210 may be a tool or a service configured to facilitate the integration, synchronization, and transfer of data between the on-premises systems, e.g., the BMS 108 in the client environment 104 and cloud-based systems, e.g., the system 102. In an example, the connection between the cloud connectors 210 and the system 102 is through the server 112. Further, in an example, the cloud connectors 210 may connect the BMS 108 with the IoT service 206 in the system 102. In an example, the IoT service 206 may establish secure connection with the server 112 for obtaining data associated with the subsystems 110 of the BMS 108 and for sending the commands from the system 102 to the client environment 104.

In an example, the cloud connectors 210 may be associated with one or more subsystem included in the BMS 108. In an embodiment, there may dedicated cloud connector 210 for each of the one or more subsystem included in the BMS 108. In an embodiment, there a single cloud connector 210 may be coupled with more than one subsystem 110 of the BMS 108. Examples of the cloud connectors 210 may include, but are not limited to, EBI cloud connector, Easy onboarding, forge connect, etc.

As previously described in the detailed description, the BMS 108 is implemented for ensuring the efficient operation and management of the one or more subsystems 110-1, 110-2, . . . , 110-n present in the client environment 104.

Referring to the onboarding of BMS 108, the system 102 may perform a plurality of steps for onboarding the BMS 108. For instance, initially, a model synchronization operation may be performed at the system 102. In this operation, data pertaining to the operational systems of the client environment 104 is transferred to the system 102, for example, by the server 112. Specifically, the data collected by the one or more subsystems 110 of the BMS 108 may be transferred to the system 102 by the server 112.

As explained previously, the server 112 facilitates the communication of information between the system 102 and the cloud environment 104. In an example, the server 112 may obtain the data collected from one or more subsystems 110 of the BMS using the cloud connectors 210. For instance, for collecting the data from a particular subsystem, the server 112 may transmit a data collection request to a corresponding cloud connector 210. Accordingly, the cloud connector 210 may trigger obtaining of the data from the subsystem 110 and may provide the same to the server 112 for transmitting to the system 102. Once the server 112 receives the data, the server 112 may transmit the same to the system 102. In an embodiment, the data includes a plurality of data points corresponding to each of the one or more subsystems 110, a plurality of point roles associated with the data points, and information about a location associated with the data points.

At the system 102, the IoT services 206 performs the task of collecting the data transmitted by the server 112. The IoT services 206 may store the data in an internal storage or a storage communicatively coupled to the system 102. The stored data may be used for performing subsequent operations for completing the onboarding of the BMS 108.

Following the model synchronization, the processor 202 may perform a contextualization process/operation on the data points. In an example, the processor 202 may utilize the cloud tool 204 for performing one or more contextualization operations on the synchronized data. Herein, the cloud tool 204 may be a data contextualization tool 204 (interchangeably “the tool 204”) which may perform the contextualization operation on the data.

In an embodiment, the cloud tool 204 may be configured to arrange the data points included in the data according to one or more predefined data formats, data structures as used in the model implemented in the system 102. As an example, the tool 204 may analyse the data and may identify the one or more subsystems 110 of the BMS 108. Accordingly, the tool 204 may then map the data points and related metadata to the respective subsystems 110 in a specific data format of the model implemented in the system 102.

Conventionally, once the data points have been contextualized and categorized based on their point roles, associated subsystems and the corresponding origin, the data points may be confirmed and exported into an Excel file. The file is then sent to a field technician. In the conventional method, the field technician visits the client site and manually enables the history for one or more data points that are of interest in the BMS system. This manual process is time-consuming and requires the technician to visit the client site, thereby incurring additional costs for onboarding.

The existing solutions involves multiple steps that are either time consuming or adding cost to the onboarding process. For instance, after modelling, the cloud engineer sends the file to the site technician and has to wait until the site technician adds the data points into the system before moving to the next onboarding process. This adds delay in the entire onboarding the site. Further, operational expenses are also increased.

The present disclosure introduces according to which the recording of the historical data for desired set of data points is performed online itself. According to aspects described, the history for the desired data points may be enabled without the requirement of having the field technician to visit the client site. In an embodiment, one or more of the cloud tools 204 may be configured to receive a user input for enabling recording of historical data associated with a set of data points from a plurality of data points pertaining to the BMS 108. Herein, the user input may be provided by a user, such as an operator operating the system 102 from a remote location or a cloud engineer or technician.

The selection of the set data points may be performed by the user working with the system 102. For instance, the system 102 may be implemented by a service provider and an employee of the service provider may provide the user input based on selection data provided by a worker from the client's end. In some examples, the selection of the set of data points may be done remotely. For instance, the worker from the client's end may remotely access the system 102, for example, using a computing device 212, such as a smartphone, a tablet, a laptop, a workstation computer, etc. Thereafter, the worker may provide the selection of the data points remotely. In some examples, the selection of the set data points may include a site visit to a site of the system 102 by the worker. Herein, the worker may prefer to visit the site of the system 102 and provide the selection accordingly, for example, using a computing device present at the site of the system 102.

To facilitate the selection of the data points for which the historical data is to be recorded, in an embodiment, the one or more cloud tools 204 may be configured to display the plurality of data points in the structured format to the user, for example, on a display. In an example, the data points that have been contextualized and categorized based on their point roles, associated subsystems and the corresponding origin are displayed to the user for selection purposes using a specific cloud tool 204 provided for displaying. Accordingly, in an embodiment, the user may select a set of data points from the plurality of data points being displayed for which the recording of the historical data is to be enabled.

In an embodiment, the user may select one or more subsystems 110 of the BMS 108 for enabling recording of the historical data. In some embodiments, the user may select the set of data points, i.e., the desired data points, from the plurality of data points pertaining to the subsystems 110 of the BMS 108.

In some embodiments, the preferred one or more subsystems 110 of the BMS 108 for which the enabling recording of historical data is required may be dependent upon the client environment 104. In an embodiment, the system 102 may automatically make the decision for the selection of preferred one or more subsystems 110 or the specific data point of any room/floor of the client environment 106 based on a type of the client environment 104. For example, when the client environment 104 is a financial institution such as a bank, the security sub system may be an important subsystem of the BMS 108 that demands focused attention. Accordingly, the system 102 may select said subsystem of the BMS and the associated data points for recording of the historical data. In another example, in a hotel environment, the lighting control system is an important subsystem of the BMS 108 to monitor. Accordingly, the system 102 may select said sub-system of the BMS and the associated data points for recording of the historical data. Herein, in said embodiment, the system 102 may provide the selected data points to the user for confirmation. The user may accordingly confirm or edit the datapoints and then confirm the selection made by the system 102.

In some examples, the system 102 may have a predefined set of data points which may be provided to the user, for example, on a display device. If found in order, the user may approve and select the predefined set of data points. Herein, the system 102 may customize the predefined set based on edits done by the user. In some examples, the system 102 may generate the predefined set of data points by applying one or more AI based techniques on the received data from the BMS 108.

Once the data points are selected, the cloud tool 204 may further display an enable history option to the user. In some embodiments, the cloud tool 204 may be configured to also provide an option to the user for selection of the interval at which the historical data associated with the set of data points is recorded and provided to the system 102 by the server 112. In one example, the could tool 204 may be configured to provide one or more predefined intervals for selection by the user in a selection pane. For example, once a week, once a month, etc. In another example, the cloud tool 204 may provide an input section for the user to manually enter the desired intervals or duration option at which the server 112 is to transmit the historical data to the system 102.

Upon the selection of enable history for the selected data points and/or the time interval, the processor 202 may generate a system command based on the set of data points. In an embodiment, the system command may be understood as a set of instructions for the client environment 104 for enabling recording of historical data associated with the selected the data points. The system command may include a list of data points associated with the subsystems 110. Further, the system command may include metadata associated with the data points, as explained previously in the description of FIG. 1. The system command may further include information about the frequency at which the historical data is to be received at the system 102. For example, system command may include instructions for sending the historical data associated with the selected data points after every seven days. In an example, after generating the system command, the processor 202 may publish the system command to the IoT service 206. The IoT service 206 may be configured to transmit the system command to the server 112.

The server 112 may be configured to receive the system command from the system 102. In an embodiment, the processor 208 may first identify one or more subsystems 110 at which the recording of the historical data would be done based on the information included in the system command. For instance, the processor 208 may access the metadata and may identify the one or more subsystems 110. In an example, the processor 208 may determine that out of, say, fifteen subsystems 110 included in the client environment 104, the data points are to be recorded for only four subsystems 110.

Once the subsystems 110 are identified, the processor 208 may subsequently determine the one or more cloud connectors 210 corresponding to the one or more subsystems 110. The processor 208 may make this determination, for instance, based on an internal mapping stored in a storage (not shown in the figure) of the client environment 104. After determining the one or more cloud connectors 210, the processor 208 may generate and transmit an enable history message to the one or more cloud connectors 210. The enable history message that is sent to a cloud connector 210 may include a gateway identity (ID) associated with the subsystem(s) 110 associated with the cloud connector 210, an enable history command, and information associated with the set of data points that are to be captured at the subsystem 110,

Using the information about the related gateway ID, the cloud connectors 112 transmit the enable history command to the respective subsystem 110 for enabling recording of the historical data associated with the selected data points at the subsystem 110. In an example, the enable history command may include the information about the set of data points that are to be captured at the subsystems 110. Accordingly, the subsystem 110 may start recording the data for the data points in a storage from where the data may be sent to the system 102 as per the specified intervals.

In an embodiment, the processor 208 may be configured to periodically fetch the recorded historical data from the storage and transmit the same to the system 102. In said embodiment, the processor 208 may fetch the data from the storage as per the frequency defined in the system command that was received at the server 112. Accordingly, the processor 208 may transmit the recorded historical data to the system 102 after predefined intervals as per the defined frequency.

In an embodiment, the IoT service 206 may be configured to monitor the receipt of recorded historical data. The IoT service 206 checks to confirm that the recorded historical data has been successfully received after each of these intervals. If the reception of the recorded historical data is disabled or interrupted, the IoT service 206 generates an alert message and sends it to the processor 208 to resolve the issue. In an example, a user device of an admin of the enterprise may also be notified about the interruption.

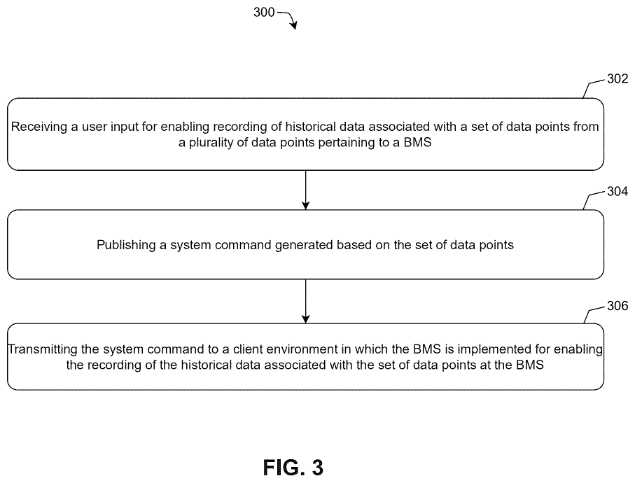

FIG. 3 illustrates a flowchart of a method 300 of onboarding a Building Management System (BMS), according to one or more embodiments of the present disclosure. The steps of the method 300, described in connection with the embodiments disclosed herein, may be embodied directly in hardware, in firmware, in a software module executed by the system 102, or in any practical combination thereof.

In some embodiments, the method 300 may be performed at a service provider's end who is offering services of collection and management of data pertaining to one or more operational systems, such as the subsystems 110 of the BMS 108 implemented in the client environment 104 of an enterprise. Herein, a subscription or a license to the services offered by the service provider may be taken by the enterprise. In an example, for onboarding the BMS 108, a plurality of data points pertaining to the BMS 108 or the subsystems thereof may be provided to the system 102, in an example. The system 102, or cloud tools implemented therein may perform one or more contextualization operations for obtaining structured data. In the structured data, the plurality of data points may be mapped to one or more subsystems of the BMS, and each of the plurality of data points may be assigned a point role. Once these operations are performed, the subsequent operations of selection of data points of interest and recording history associated therewith are performed as explained below.

At step 302, the method 300 includes receiving a user input for enabling recording of historical data associated with a set of data points from a plurality of data points pertaining to the BMS 108. As explained previously in the detailed description, the BMS 108 may have one or more subsystems 110. In some examples, A user seeking to have the history enabled for desired data points may provide the user input and select a preferred subsystem from the subsystems 110 or may select specific data points associated with the one or more subsystems 110 that are of interest and for which recording of the historical data is to be enabled.

In an example, the user input may be provided by a person working with the implementor of the system 102 for enabling recording of historical data associated with the BMS 108. As an example, a worker at the service provider end, say, worker A, may receive an email including details of the data points for which the history is to be enabled. Accordingly, the worker A may provide the user input that is received by the system 102.

In another example, the user input may be provided by a person, say, an admin worker, employed at the client environment 104. Herein, the admin worker may provide the input to the system 102 for enabling recording of historical data associated with the data points pertaining to the BMS 108. The user input may be provided remotely, for example, using a computing device which is installed at the client environment 104 and which is connected to the system 102. In another example, the admin worker may prefer a site visit to the site of the system 102 and provide the user inputs there, say, to the worker A. In either case, the system 102 receives the user input.

In some embodiments, the user input may be received using the cloud tool 204. For instance, the cloud tool 204 may provide the user a list of data points associated with the one or more subsystems 110 of the BMS 108 in a structured format on a display of the computing device 212. Herein, the structured format may be understood as the data points being organized based on their point roles, associated subsystems, and the corresponding origin. From the plurality of data points displayed in the list, the user may select a set of data points for which the recording of the historical data is to be enabled. In some embodiments, the user may select all the data points associated with one or more sub-system 110 completely for which the recording of the historical data is to be enabled. In some embodiments, the user may select specific subsystems 110 and the recording is enabled for the data points corresponding to the specific subsystems 110. In some embodiments, the user may select specific data points classified under the different subsystems 110 and accordingly, the history may be enabled for such data points.

Once the data points are selected, the user may be provided with an option to enable history related to said points. In an example, a checkbox labelled “Enable History” may be displayed next to each of the selected data point for user to select. In another example, the user may have to right-click on a selected data point and a context menu may appear with an option to enable history. In another example, a pop-up confirmation dialog may appear and ask if the user want to enable history for the selected data points, once the selection of data points is done. The user may then confirm their choice through a pop-up. Said action of providing the options for enable history may be provided by the cloud tool 204 in the system 102.

In some embodiments, the user may be provided with an option for selection of the interval at which the historical data associated with the set of data points is recorded and provided to the system 102 by the server 112. In one example, a dropdown menu may be provided to user to select the interval from the list of predefined options. The predefined options comprising times interval as one day, one week, one month, etc. The user may click on the dropdown menu and select the desired interval. In another example, the radio buttons may be provided to user for selecting clear set of interval choices. In another example, a combination of a text input and a dropdown may be provided in setting custom intervals to the user. The user may input a number in the text input field and select the unit (minutes, hours, or days) from the dropdown. Said action of providing the options for selection of the interval may be provided by the cloud tool 204 in the system 102.

At step 304, the method 300 includes publishing a system command generated based on the set of data points. In an embodiment, the one or more cloud tools 204 may be configured to publish the generated system command to the IoT service 206. In an embodiment, once the data points are selected and the recording of history along with the required time interval is enabled for these data points, information associated with the data points and the required time interval may be provided to the processor 202. Accordingly, the system command may be generated by the processor 202 based on the selected data points. The system command may then be provided by the processor 202 to the cloud tool 204 for publishing to the IoT service 206.

In an embodiment, the system command may be understood as a set of instructions for enabling recording of historical data associated with the selected the data points. For example, the user may select data points from the display of the computing device 212. The user may then choose to enable history recording for these data points and selects the interval for recording, e.g., every 2 days. The processor 202 may then collects metadata related to the selected data points. In some examples, the metadata may include the data point ID, associated subsystem ID, data type, etc. Based on the selected data points, related metadata, and time interval as defined or predetermined, the processor 202 may generate the system command. Accordingly, the system command may include a list of the selected data points along with the IDs of the selected data points, associated subsystems and their corresponding IDs and/or gateway of these subsystems, and the interval which includes frequency at which historical data should be recorded.

In some embodiments, the generated system command may then be provided to the cloud tool 204 for publishing to the IOT service 206. In an example, the interface of the computing device 212 coupled with the IoT service 206 may display the system command. In an example, the system command may be as follows:
System Command Received:
Command Type: Enable History
Data Points:
Temperature Sensor (ID: temp_001, Subsystem: HVAC_01)
Humidity Sensor (ID: hum_001, Subsystem: HVAC_01)
Recording Interval: Every 2 days
Status: Command Accepted
Next Recording: Scheduled for [Date/Time]

At step 306, the method 300 includes transmitting the system command to a client environment in which the BMS is implemented for enabling the recording of the historical data associated with the set of data points. In an example, the transmission of the system command may be performed by the IoT service 206.

In an embodiment, the system command generated at the system 102 may be transmitted to the client environment 104 wherein the one or more subsystem 110 of the BMS 108 are accordingly instructed to enable the history of data points mentioned in said system command. Accordingly, the one or more subsystem 110 may be configured to record history pertaining to selected data points in specified time intervals for subsequently sending to the system 102.

In an embodiment, at the client environment 104, the server 112 may receive and process the system command. For instance, the information included in the system command may be analysed by the server 112 to identify the one or more subsystems 110 corresponding to the selected data points. Once the subsystems 110 are identified, the server 112 may determine the corresponding cloud connectors 210 for these subsystems 110 and transmit a enable history message to the respective cloud connectors 210 of these one or more subsystems 110. The enable history message includes a gateway ID of the subsystem 110, the list of the data points, and an enable history command.

On receiving the enable history message, the cloud connectors 210 may transmit an enable history command to the respective subsystems 110 for enabling recording of the historical data associated with the data points being handled by the subsystem 110. The enable history command includes the list of data points being handled by the subsystem 110. The subsystem 110 accordingly stars recording the data associated with the specified data points and stored them in a storage. The recorded historical data may be periodically fetched from the storage and transmitted to the system 102 as per the defined time interval.

In an embodiment, the IoT service 206 at the system 102 monitors the receipt of this recorded historical data. The IoT service 206 checks to confirm that the recorded historical data has been successfully received after each of these intervals. If the reception of the recorded historical data is disabled or interrupted, the IoT service 206 generates an alert message and sends it to the processor 210 to resolve the issue.

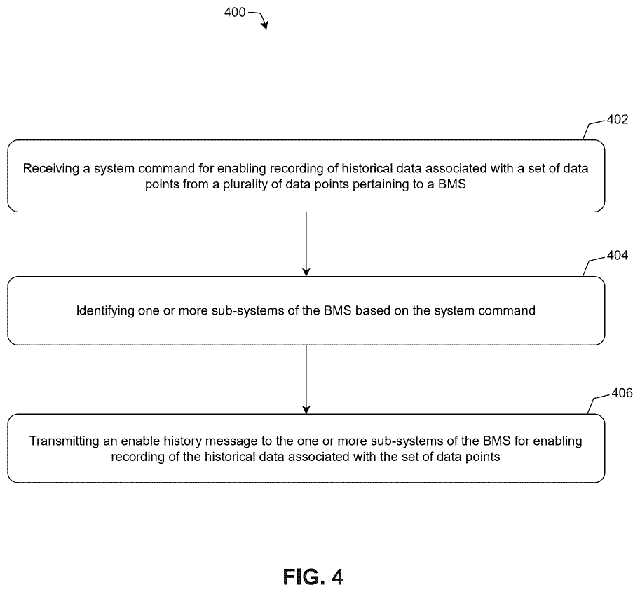

FIG. 4 illustrates a flowchart of a method 400 of onboarding a Building Management System (BMS), according to one or more embodiments of the present disclosure. The steps of the method 400, described in connection with the embodiments disclosed herein, may be embodied directly in hardware, in firmware, in a software module executed by the client environment 104, or in any practical combination thereof.

Once the system command from the system 102′ end is transmitted to the client environment 104, the further process of completing the onboarding of the BMS 108 may be performed at the client environment's 104 end. At step 402, the method 400 includes receiving a system command for enabling recording of historical data associated with a set of data points from a plurality of data points pertaining to a BMS. In an example, the system command transmitted by the IoT service may be received by a server, such as the server 112. The system command, in some examples, may include a list of the data points for which the history recording is to be enabled. The system command may further include a list of subsystems 110 corresponding to the data points. The system command may further include, a gateway of corresponding subsystems 110 which correspond to these data points. In some examples, these gateways may be determined at the server 112, for example, using a data point-gateway mapping. In some examples, the system command may further include a time interval at which the recorded data is to be transmitted to the system 102.

At step 404, one or more subsystems 110 corresponding to the set of data points for which history is to be enabled are identified based on the system command. In an example, the server 112 may analyze the system command and may identify the subsystems 110 corresponding to the data points mentioned in the system command. For instance, the server 112 may refer to the list of subsystems 110 corresponding to the list of the data points. Based on the list, the server 112 may identify the one or more subsystems 110. In another example, each data point specified in the system command may have associated metadata which includes an ID of the corresponding subsystem. In such a case, the server 112 may analyze the system command and may identify the subsystem corresponding to the listed data points accordingly.

At step 406, an enable history message is transmitted to one or more cloud connectors 210 corresponding to the identified subsystems 110 for enabling the recording of the historical data associated with the set of data points. The enable history message, in some examples, may include a gateway identity associated with the one or more subsystems, an enable history command, and information associated with the set of data points that are to be captured at the one or more subsystems.

Once the subsystems 110 associated with the set of data points have been identified, the server 112 may determine the one or more cloud connectors 210 which are associated with these subsystems 110. These cloud connectors 210 are configured to manage the integration of the subsystems 110 to the cloud services offered by the system 102. For instance, the cloud connectors 210 may be configured to execute the instructions received from the system 102 at these subsystems 110, create and transmit new instructions based on triggers or instructions received from the system 102. In an example, the server 112 may have a list of cloud connectors 210 and related subsystems 110 which may be used for determining the cloud connectors 210 coupled to the subsystems 110.

Once the cloud connectors 210 are determined, the server 112 may transmit the enable history message to the cloud connectors 210. Based on the gateway information included in the enable history message, each of the cloud connectors 210 may transmit the enable history command to the respective subsystems 110 associated therewith for recording the historical data associated with the data points. On receiving the enable history command, the subsystems 110 associated may start recording the historical data associated with the data points. The historical data may be understood as a plurality of values of the data points collected over a defined period.

In some embodiments, the historical data collected by the one or more sub-system of the BMS 108 may be transmitted to the server 112 using the corresponding cloud connectors 210. In an embodiment, the cloud connectors 210 may transmit the historical data corresponding to the set of data points from after the predetermined interval as indicated in the system command. For example, if the interval of transmitting the recorded historical data was mentioned as one week in the system command, the historical data that has been recorded till one week may be provided by the cloud connectors 210 to the server 112. The server 112 may then transmit the historical data corresponding to the set of data points to the cloud IoT service 206 of the system 102. In some embodiments, the data is stored in the storage and the server 112 may periodically fetch the data from the storage as per the defined frequency in the system command, and transmit the historical data to the system 102.

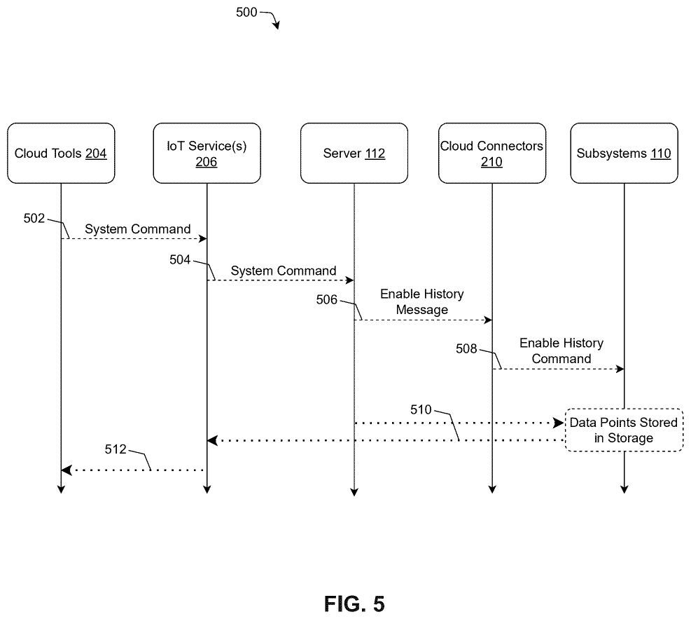

FIG. 5 illustrates a call flow diagram 500 for onboarding a BMS, such as the BMS 108, according to one or more embodiments of the present disclosure. Without limitation, the call flow diagram 500 illustrates one more of communication messages, information, data, instructions, etc., being exchanged between various nodes/elements of the system 102 and the client environment 104.

At step 502, a system command is published by the one or more cloud tools 204 to the IoT service(s) 206. In some examples, the system command may include a list of the data points for which the recording of historical data is to be enabled. In some examples, the system command may further include information about a frequency at which the server 112 of the client environment 104 is to transmit the recorded historical data of the set of data points to the IoT service 206.

At step 504, the system command is transmitted from the IoT service 206 to the server 112. The published system command is transmitted to the server 112 by the IoT service 206, for example, using the communication network 106.

At step 506, an enable history message is transmitted by the server 112 to the one or more cloud connectors 210. In some examples, the server 112 may determine the subsystems 110 at which the history of the data points is to be recorded based on the system command. Accordingly, the server 112 may then determine the cloud connectors 210 corresponding to these subsystems 110 and may generate the specific enable history messages that are to be sent to these cloud connectors 210.

In some examples, the enable history message that is sent to a cloud connector 210 may include a gateway of the subsystem 110, an enable history command, and information associated with the set of data points whose history is to be captured at the subsystem 110.

At step 508, an enable history command is transmitted by the cloud connectors 210 to the one or more subsystems 110. Based on the enable history message received from the server 112, the cloud connectors 210 may transmit the enable history command to the respective subsystems 110. The enable history command may also include the information relating to the data points for which the recording of the historical data is to be enabled. On receiving the enable history command, the subsystem 110 accordingly starts capturing the data pertaining to the specified data points for formulating the historical data for the points. The historical data is stored in a storage of the client environment 104.

At step 510, the data points stored in the storage of the client environment are transmitted by the server 112 to the IoT service 206. Herein, the server 112 may obtain the historical data associated with the set of data points from the storage at periodic intervals as specified in the system command. After obtaining the historical data at the periodic intervals, the server 112 may transmit the historical data to the IoT service 206, for example, over the communication network 106.

At step 512, the IoT service 206 transmits the received data points to the cloud tools 204. This action may include storing the historical data in a storage of the system 102 and notifying the cloud tools 204 about the historical data received by the IoT service 206. In another example, the cloud tools 204 may store the historical data in the storage.

The connecting lines shown in the various figures contained herein are intended to represent exemplary functional relationships and/or physical couplings between the various elements. It should be noted that many alternative or additional functional relationships or physical connections may be present in an embodiment of the subject matter.

The subject matter may be described herein in terms of functional and/or logical block components, and with reference to symbolic representations of operations, processing tasks, and functions that may be performed by various computing components or devices. It should be appreciated that the various block components shown in the figures may be realized by any number of hardware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices. Furthermore, embodiments of the subject matter described herein can be stored on, encoded on, or otherwise embodied by any suitable non-transitory computer-readable medium as computer-executable instructions or data stored thereon that, when executed (e.g., by a processing system), facilitate the processes described above.

The foregoing description refers to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the drawings may depict one exemplary arrangement of elements directly connected to one another, additional intervening elements, devices, features, or components may be present in an embodiment of the depicted subject matter. In addition, certain terminology may also be used herein for the purpose of reference only, and thus are not intended to be limiting.

The foregoing detailed description is merely exemplary in nature and is not intended to limit the subject matter of the application and uses thereof. Furthermore, there is no intention to be bound by any theory presented in the preceding background, brief summary, or the detailed description.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the subject matter in any way. Rather, the foregoing detailed description will provide those skilled in the art with a convenient road map for implementing an exemplary embodiment of the subject matter. It should be understood that various changes may be made in the function and arrangement of elements described in an exemplary embodiment without departing from the scope of the subject matter as set forth in the appended claims. Accordingly, details of the exemplary embodiments or other limitations described above should not be read into the claims absent a clear intention to the contrary.

1-4. (canceled)

5. A method of onboarding a Building Management System (BMS), the method comprising:
receiving, by a server implemented in a client environment, a system command for enabling recording of historical data associated with a set of data points from a plurality of data points pertaining to the BMS implemented in the client environment;
identifying, by the server based on the system command, one or more subsystems of the BMS that are corresponding to the set of data points; and
transmitting, by the server, an enable history message to one or more cloud connectors corresponding to the one or more subsystems of the BMS for enabling recording of the historical data associated with the set of data points.

6. The method of claim 5, wherein the enable history message comprises a gateway identity associated with the one or more subsystems, an enable history command, and information associated with the set of data points that are to be captured at the one or more subsystems.

7. The method of claim 5, further comprising:
obtaining, by the one or more cloud connectors, the historical data corresponding to the set of data points from the one or more subsystems of the BMS after a predetermined interval; and
transmitting, by the one or more cloud connectors, the obtained historical data corresponding to the set of data points to the server for transmitting to a cloud IoT service.

8-11. (canceled)

12. A system for onboarding a Building Management System (BMS), the system comprising:
one or more processors;
the BMS comprising one or more subsystems;
a plurality of cloud connectors coupled to the one or more processors and the BMS,
wherein the one or more processors are configured to:
receive, from a cloud IoT service, a system command for enabling recording of historical data associated with a set of data points from a plurality of data points pertaining to the BMS;
identify, based on the system command, one or more subsystems of the BMS that are corresponding to the set of data points; and
transmit an enable history message to one or more cloud connectors corresponding to the one or more subsystems of the BMS for enabling recording of the historical data associated with the set of data points.

13. The system of claim 12, wherein the enable history message comprises a gateway identity associated with the one or more subsystems, an enable history command, and information associated with the set of data points that are to be captured at the one or more subsystems.

14. The system of claim 12, wherein the one or more cloud connectors are further configured to:
obtain the historical data corresponding to the set of data points from the one or more subsystems of the BMS after a predetermined interval; and
transmit the obtained historical data corresponding to the set of data points to the one or more processors for transmitting to a cloud IoT service.

15-18. (canceled)

19. A computer-readable medium having computer-executable instructions stored thereon that, when executed by a processing system, cause the processing system to:
receive a system command for enabling recording of historical data associated with a set of data points from a plurality of data points pertaining to a Building Management System (BMS);
identify, based on the system command, one or more subsystems of the BMS that are corresponding to the set of data points; and
transmit an enable history message to one or more cloud connectors corresponding to the one or more subsystems of the BMS for enabling recording of the historical data associated with the set of data points.

20. The computer-readable medium of claim 19, wherein the computer-executable instructions cause the processing system to:
obtain the historical data corresponding to the set of data points from the one or more subsystems of the BMS after a predetermined interval; and
transmit the obtained historical data corresponding to the set of data points to a cloud IoT service.

21. The method of claim 5, further comprising:
receiving, by one or more cloud tools, a user input for enabling the recording of the historical data associated with the set of data points;
publishing, by the one or more cloud tools to an IoT service, the system command generated based on the set of data points, in response to receiving the user input for enabling the recording of the historical data associated with the set of data points; and
transmitting, by the IoT service, the system command to the client environment.

22. The method of claim 21, further comprising:
receiving, by the one or more cloud tools, the plurality of data points; and
performing, by the one or more cloud tools, one or more contextualization operations on the plurality of data points for obtaining structured data, wherein the structured data comprises the plurality of data points mapped to the one or more subsystems of the BMS, and wherein each of the plurality of data points is assigned a point role.

23. The method of claim 22, further comprising:
displaying the plurality of data points in a structured format to a user;
receiving, using the one or more cloud tools, a selection of the set of data points selected by the user from the plurality of data points pertaining to the BMS displayed to the user; and
displaying, for selection, an enable history option to the user, in response to receiving the selection of the set of data points from the user.

24. The method of claim 21, further comprising:
receiving, by the IoT service, the recorded historical data corresponding to the set of data points after predetermined time intervals;
determining, by the IoT service, successful receipt of the recorded historical data after the predetermined time intervals; and
generating, by the IoT service, an alert message on determining that the reception of the recorded historical data is disabled or interrupted.

25. The system of claim 12, further comprising:
an IoT service coupled to the one or more processors; and
one or more cloud tools operatively coupled to the IoT service and the one or more processors, wherein the one or more cloud tools are configured to:
receive a user input for enabling the recording of the historical data associated with the set of data points; and
publish, to the IoT service, the system command generated based on the set of data points in response to the user input, wherein the IoT service is configured to transmit the system command to a client environment in which the BMS is implemented for enabling the recording of the historical data associated with the set of data points at the BMS.

26. The system of claim 25, wherein the one or more cloud tools are further configured to:
receive the plurality of data points; and
perform one or more contextualization operations on the plurality of data points for obtaining structured data, wherein the structured data comprises the plurality of data points mapped to the one or more subsystems of the BMS, and wherein each of the plurality of data points is assigned a point role.

27. The system of claim 26, wherein the one or more cloud tools are further configured to:
display the plurality of data points in a structured format to a user;
receive a selection of the set of data points selected by the user from the plurality of data points pertaining to the BMS displayed to the user; and
display, for selection, an enable history option to the user based on the selection of the set of data points by the user.

28. The system of claim 25, wherein the IOT service is further configured to:
receive the recorded historical data corresponding to the set of data points after predetermined time intervals;
determine successful receipt of the recorded historical data after the predetermined time intervals; and
generate an alert message based on the determination that the reception of recorded historical data is disabled or interrupted.

29. The computer-readable medium of claim 19, wherein the computer-executable instructions cause the processing system to:
receive a user input for enabling the recording of the historical data associated with the set of data points;
publish the system command generated based on the set of data points, in response to the user input; and
transmit the system command to a client environment in which the BMS is implemented for enabling the recording of the historical data associated with the set of data points at the BMS.

30. The computer-readable medium of claim 29, wherein the computer-executable instructions cause the processing system to:
receive the plurality of data points; and
perform one or more contextualization operations on the plurality of data points for obtaining structured data, wherein the structured data comprises the plurality of data points mapped to the one or more subsystems of the BMS, and wherein each of the plurality of data points is assigned a point role.

31. The computer-readable medium of claim 30, wherein the computer-executable instructions cause the processing system to:
display the plurality of data points in a structured format to a user, and
receive a selection of the set of data points selected by the user from the plurality of data points pertaining to the BMS displayed to the user, and
display, for selection, an enable history option to the user based on the selection of the set of data points by the user.

32. The computer-readable medium of claim 29, wherein the computer-executable instructions cause the processing system to:
receive the recorded historical data corresponding to the set of data points after predetermined time intervals;
determine successful receipt of the recorded historical data after the predetermined time intervals; and
generate an alert message based on the determination that the reception of recorded historical data is disabled or interrupted.
